(19) United States
(12) Patent Application Publication
(10) Pub. No.: US 2006/0084397 A1
(43) Pub. Date: Apr. 20, 2006

(54) Shielding assembly for an RF sensor current transducer

(76) Inventors: Terry R. Turner, Austin, TX (US); Rodney A. Herman, Austin, TX (US); Duane T. Smith, Round Rock, TX (US); James D. Spain, Georgetown, TX (US)

Correspondence Address: FORTKORT GRETHER + KELTON LLP, 9442 N. Capital of Texas Hwy., Suite 500, AUSTIN, TX, 78759, US

(21) Appl. No.: 10/954,459

(22) Filed: Sep. 30, 2004

(51) Int. Cl. H04B 1/38

(52) U.S. Cl. 455/117; 455/90.1; 455/300

(57) ABSTRACT

An RF sensor is provided herein. The sensor comprises a clamping mechanism (101), a metal collar (113) disposed about the clamping mechanism, an RF current transducer (203) having a transducer coil (213) disposed on a circuit board (126), the RF current transducer being disposed adjacent to the collar, and a metal housing (215) for the transducer coil, the housing being mounted on the circuit board and having first and second open ends.

### CROSS-REFERENCE TO RELATED PATENT APPLICATIONS

This patent application claims priority to U.S. Provisional Patent Application No. 10/668,398, filed Sep. 23, 2003, entitled “Transducer Package for Process Control”, and incorporated herein by reference; to U.S. Ser. No. 60,468,414, filed May 6, 2003, entitled “RF Sensor Voltage Transducer”, and incorporated herein by reference; to U.S. Ser. No. 60/468,412, filed May 6, 2003, entitled “RF Detector for Semiconductor Processing”, and incorporated herein by reference; to U.S. Ser. No. 60/468,413, filed May 6, 2003, entitled “RF Sensor Current Transducer”, and incorporated herein by reference; to U.S. Ser. No. 60/486,983, filed Jul. 14, 2003, entitled “RF Power Sensor for Known Fixed Impedance Environments”, and incorporated herein by reference; to U.S. Ser. No. 60/487,745, filed Jul. 16, 2003, entitled “An RF Delivery Diagnostic System”, and incorporated herein by reference; to U.S. Ser. No. 60/412,752, filed Sep. 23, 2002, entitled “RF Sensor for Process Control”, and incorporated herein by reference; and to U.S. Ser. No. 10/851,423, filed May 20, 2004, entitled “RF Sensor Clamp Assembly”, and incorporated herein by reference.

### FIELD OF THE INVENTION

The present invention relates generally to RF sensor current transducers, and more particularly to methods and devices for shielding such transducers from electric and magnetic fields.

### BACKGROUND OF THE INVENTION

Plasma etch and deposition processes have become the dominant pattern transfer means used in semiconductor manufacturing over the past 20 years. Most plasma based processes employ the fundamental principle of disassociation of a feed gas by the application of radio frequency (RF) power. As with all plasma loads, one of the dominant characteristics of the plasma load is its non-linearity. The non-linearity of the load affects the voltage and current sine waves of the delivered RF power by creating prevalent harmonic distortion. The exact amount of harmonic distortion, as represented by the amplitude of the harmonic frequencies and the associated phase angle of the current harmonic relative to the corresponding voltage harmonic, is unique to the plasma creating them. To be more precise, the plasma parameters, including ion and electron densities and energies, collision frequencies, neutral constituents, and their respective densities all contribute in a unique way to the amplitude of specific harmonic components of the fundamental frequency applied by a power delivery source to achieve the desired disassociation and subsequent process results.

It is thus apparent that, by monitoring the harmonic components of the fundamental frequency applied by a power delivery source, enhanced process control of plasma deposition and etch processes may be obtained. Consequently, several products have been developed that are designed to provide enhanced process control by monitoring such RF harmonic content. Unfortunately, wide scale proliferation of this technology has not been realized due to several fundamental limitations in the available technology.

One issue with existing devices for monitoring the harmonic content of delivered RF power concerns the shielding of the inductive transducer. Due to the pressure-flow regime and the molecular stability of many gases used in semiconductor processing, often a relatively high RF voltage is required to initialize and sustain the process plasma. In addition, the diode-like characteristics of plasmas can cause the RF current flow after ignition to be very high. The RF power is typically delivered to a capacitively coupled electrode where the flow of DC current is blocked, thus resulting in a DC “self-bias” voltage. Consequently, there is not always a need for a DC coupled RF current transducer to monitor the current component of the delivered RF power. However, there is a vital need to protect the simple inductive monitoring device, which operates in accordance with Faraday's Law, from stray fields (both magnetic as well as electric) that can significantly impact the potential for accurate RF current measurements.

Boundary condition analysis suggests that the optimal placement of a grounded shield is between the inductive transducer and the RF current carrier. Such a placement properly shields the inductive transducer from the electric field radiating from the primary RF current carrier, and avoids crosstalk between voltage and current. Moreover, in order to shield the inductive transducer from stray electric and magnetic fields which may be in the ambient environment local to the measurement (such as the coil of an impedance matching network), it is often desirable to enclose the inductive transducer in a grounded shield. Unfortunately, the use of conventional shields to protect the transducer from ambient stray fields also impedes the measurement of the desired primary RF current magnetic field.

Various shield designs have been proposed in the art. However, none of these designs overcome the above noted infirmities. Thus, for example, U.S. Pat. No. 5,808,415 (Hopkins) and U.S. Pat. No. 6,061,006 (Hopkins) teach a dual loop antenna approach for monitoring RF current. U.S. Pat. No. 6,501,285 (Hopkins et al.) teaches an approach to assembling the inductor using individual printed circuit boards interconnected with metal filled vias to provide connection between the respective layers. U.S. Pat. No. 5,834,931 (Moore et al.) teaches a single turn, first principles implementation of Faraday's law which, unfortunately, is limited by the propensity for arcing between the primary RF current carrier and the shield of the inductive loop.

There is thus a need in the art for a means to protect inductive monitoring devices which operate in accordance with Faraday's Law from stray fields (both magnetic as well as electric) that can significantly impact the potential for accurate RF current measurements. There is also a need in the art for such a device that does not impede the measurement of the desired primary RF current magnetic field. These and other needs are met by the devices and methodologies disclosed herein and hereinafter described.

### BRIEF DESCRIPTION OF THE DRAWINGS

For a more complete understanding of the present invention, and the advantages thereof, reference is now made to the following brief descriptions taken in conjunction with the accompanying drawings, in which like reference numerals indicate like features.

FIG. 1 is a functional block diagram of an RF detector made in accordance with the teachings herein;

FIGS. 2-3 are perspective views of an RF sensor clamp assembly useful in the RF sensors taught herein;

FIG. 4 is an exploded side view of the RF sensor clamp assembly of FIG. 2;

FIGS. 5-7 are exploded perspective views of the RF sensor clamp assembly of FIG. 2;

FIG. 8 is a perspective view of an RF sensor made in accordance with the teachings herein which incorporates the RF sensor clamp assembly of FIG. 2;

FIG. 9 is an exploded perspective view of the RF sensor of FIG. 8;

FIGS. 10-11 are perspective views showing the placement on a PCB of one embodiment of a shielding mechanism for an RF sensor current transducer made in accordance with the teachings herein;

FIGS. 12-13 are close-up perspective views of the shielding scheme depicted in FIGS. 10-11;

FIG. 14 is a side view, partially in section, of another embodiment of a shielding mechanism for an RF sensor current transducer made in accordance with the teachings herein;

FIG. 15 is a top view of the shielding mechanism of FIG. 14; and

FIG. 16 is a side view of the shielding mechanism of FIG. 14.

### SUMMARY OF THE INVENTION

In one embodiment, an RF sensor is provided which comprises a metal collar, a metal housing disposed adjacent to said collar and having first and second open ends, and a transducer coil disposed within said housing.

In another embodiment, a device is provided herein which comprises an RF current transducer and a housing assembly for the transducer. The housing assembly comprises a metal top and metal side walls and is constructed such that, when it is placed on a planar substrate, the side walls slant away from the top and towards the substrate. The transducer, which may be an RF current sensor or other inductive monitoring device which operates in accordance with Faraday's Law, is protected by the housing from stray fields (both magnetic as well as electric) that can significantly impact the ability of the transducer to provide accurate RF current measurements. However, the housing assembly does not impede the measurement of the desired primary RF current magnetic field. Other aspects, objectives and advantages of the devices and methodologies disclosed herein will become more apparent from the remainder of the detailed description when taken in conjunction with the accompanying drawings.

### DETAILED DESCRIPTION OF THE INVENTION

Prior to describing the details of the housing assemblies described herein, an overview of the RF sensors that incorporate these assemblies may be useful. In the preferred embodiment, these RF sensors are suitable for use with plasma reactors, and utilize a novel clamp assembly (described in greater detail below) that enables the sensor to be readily attached to the outer surface of an RF current carrier. Since the sensor merely attaches to the surface of the RF current carrier, it does not add to the electrical length of the RF current carrier, and it does not require the current carrier to be broken in order to accommodate the sensor. Consequently, the sensor permits the characteristics (e.g., phase angle, DC voltage, RF voltage, and RF current) of the RF power supply and current carrier to be measured without significantly modifying any of these attributes. Therefore, use of the clamp assembly avoids the need for recalibration after the sensor is attached to the current carrier.

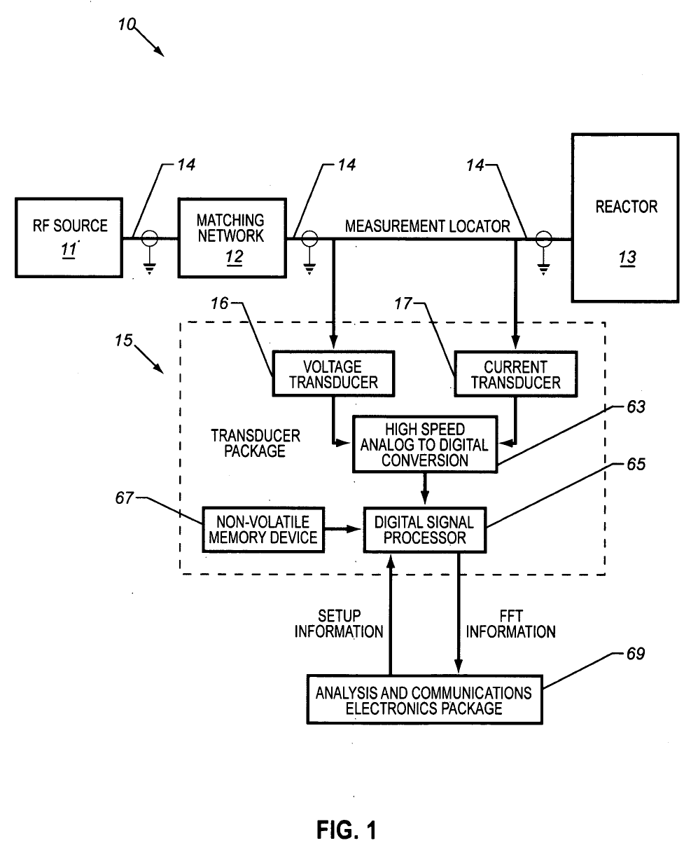

FIG. 1 is a block diagram which depicts the placement and general layout of an RF sensor incorporating the housing assemblies described herein. In one non-limiting embodiment of an RF controlled system 10 made in accordance with the teachings herein, an electrical source in the form of an RF generator 11 (RF source) is coupled to a processing reactor 13 through a matching network 12 by transmission line 14. The reactor 13 can be any of a variety of reactors, including plasma reactors, which are used for processing a variety of materials, including semiconductor wafers. Moreover, one skilled in the art will appreciate that the teachings herein can be applied to a variety of processing systems, or combinations of such systems, that utilize electrical or microwave energy (including RF) sources. Furthermore, while the use of a matching network 12 is preferred, it is not necessarily needed in all applications of the sensor described herein.

As shown in FIG. 1, a transducer package 15 is attached to the transmission line 14 in a location proximal to the reactor 13, and is preferably disposed at some point after the matching network 12. It is preferred to have the transducer package 15 in as close proximity to the reactor 13 as possible, so that the measurements obtained from the transducer package 15 are indicative of actual V and I values entering the reactor 13. Both V and I values are sensed at substantially the same point on the transmission line 14 in order to determine the power entering the reactor 13 and, in some instances, a phase relationship between V and I.

Appropriate broadband voltage 16 and current 17 transducers are incorporated into the transducer package 15. These transducers are designed to sample, respectively, the voltage and current components of the delivered RF power. The transducer package further includes a high speed analog to digital converter (ADC) 63, a digital signal processor (DSP) 65, and a (preferably non-volatile) memory device 67. The transducer package 15 is maintained in a measurement location which is local to the RF transmission line 14.

The configuration shown in FIG. 1 further comprises an analysis and communications package 69 which is located remote from the transducer package 15. Communications between the transducer package 15 and the remote analysis and communications package 69 typically comprise setup commands sent to the DSP necessary for proper operation.

The memory device 67 included in the transducer package stores necessary calibration information specific to the transducer package for access by the system. This device may also be used to store other appropriate information, such as serial numbers and data required for tracking purposes. Typically, the memory device will be a built-in component of one of the PCBs utilized in the RF sensor, but other types of memory devices may also be utilized, including removable memory chips that are insertable into a port provided on a PCB. Memory devices may also be utilizes that are not directly attached to a PCB, but are in communication with the appropriate circuitry, as by wireless transmission or other suitable means.

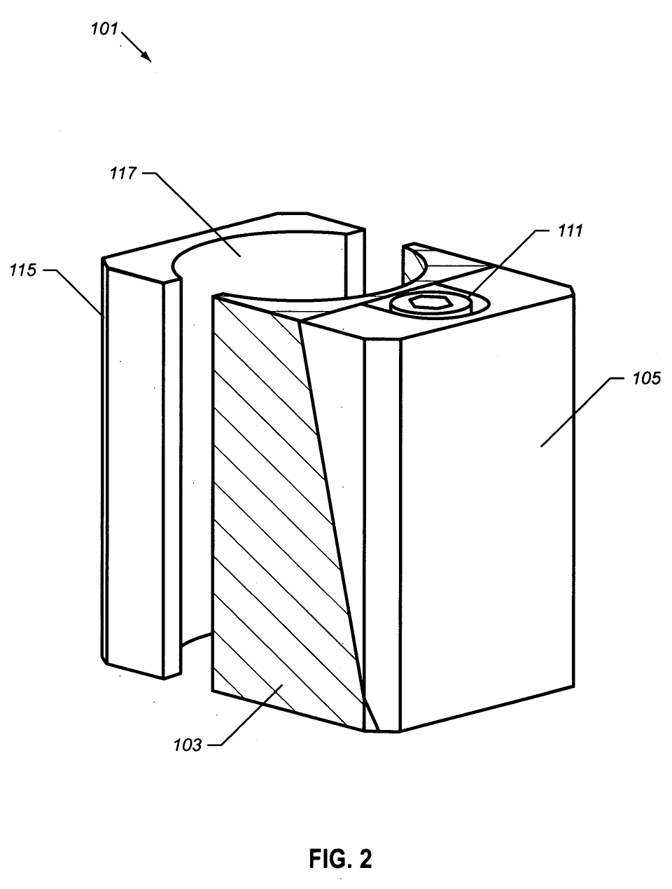

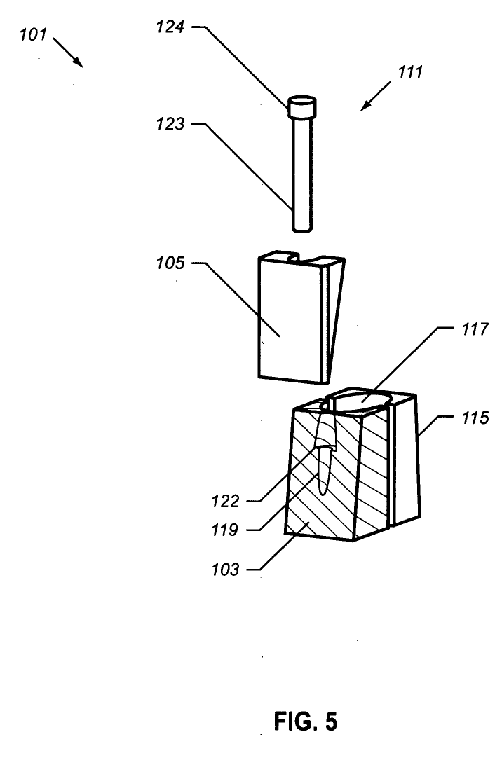

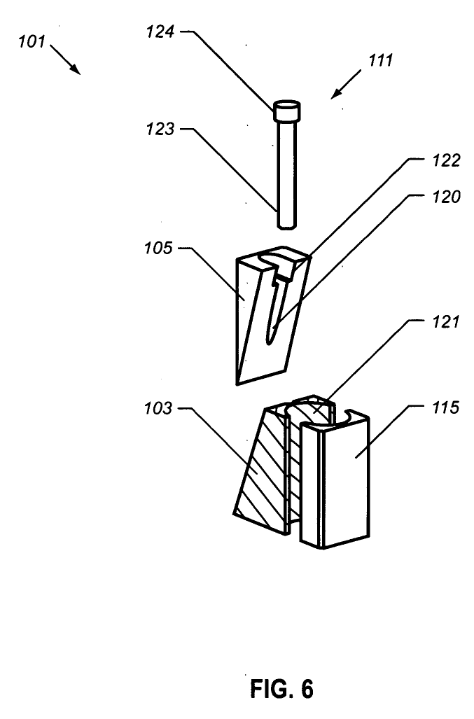

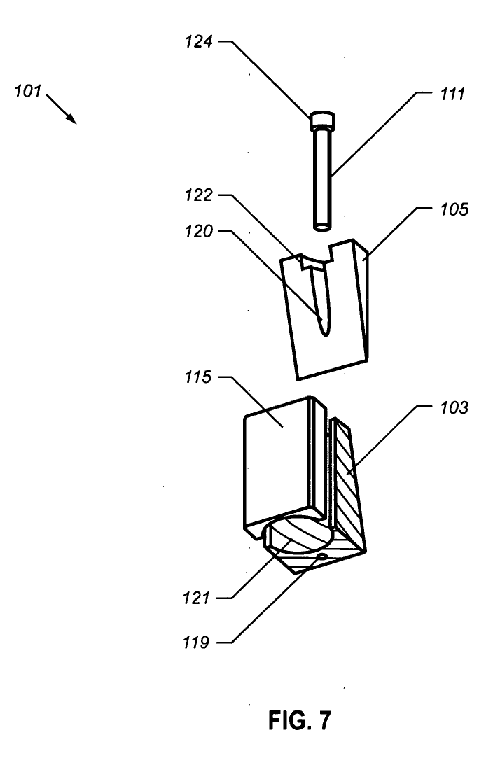

FIGS. 2-7 depict one embodiment of a clamp assembly useful in the RF sensors disclosed herein when used in conjunction with rod-shaped current carriers. Such current carriers commonly have a diameter of 0.5″ or 0.625″. One skilled in the art will appreciate, however, that the devices described herein are not specifically limited to current carriers of any particular diameter or shape, and that the dimensions of these devices can be appropriately modified to accommodate current carriers of other diameters and shapes. In particular, various other designs for clamping mechanisms useful in the devices described herein are described in commonly assigned U.S. Ser. No. 10/851,423, filed on May 21, 2004 and entitled “RF sensor Clamping Mechanism”, which is incorporated by reference herein in its entirety, and any of these clamping mechanisms may be used in the devices described herein.

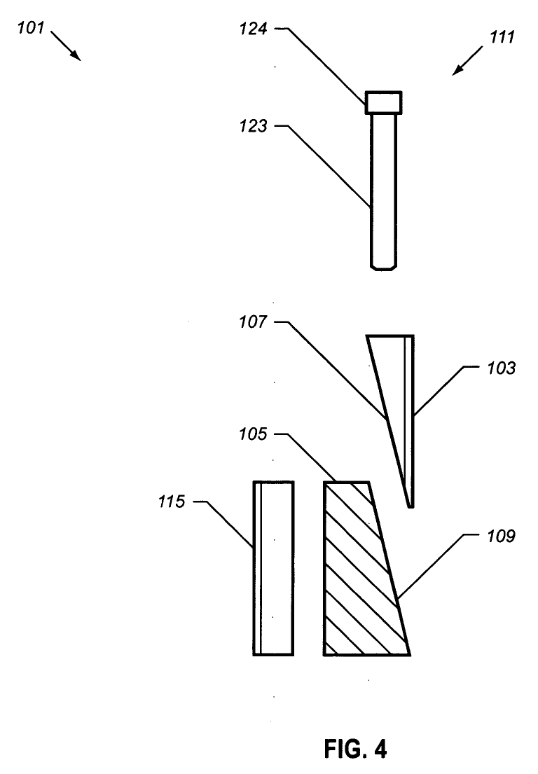

Referring again to FIGS. 2-7, the clamp assembly 101 shown therein comprises first 103 and second 105 wedge inserts that are slidingly engaged across first 107 and second 109 opposing surfaces (see, e.g., FIG. 4) by means of a fastener, which in this particular embodiment is a socket head cap screw 111. As the cap screw is tightened (typically by rotating it in a clockwise manner), the assembly of the first 103 and second 105 wedge inserts expands. Conversely, as the cap screw is loosened (typically by rotating it in a counterclockwise manner), the assembly of the first 103 and second 105 wedge inserts contracts or relaxes. Although not specifically shown, the cap screw preferably has a threaded surface on its shaft 123 (see FIG. 4) that rotatingly engages complimentary threads provided on the surfaces of apertures that are provided in wedge inserts 103 and 105, respectively. The cap screw 111 is also provided with a cap 124 that halts the progress of the screw in the axial direction when the cap abuts a ledge 122 defined in the aperture. The aperture 119 may extend through the bottom of wedge insert 103 to permit the egress of metal shavings or other debris that may accumulate in the aperture from time to time.

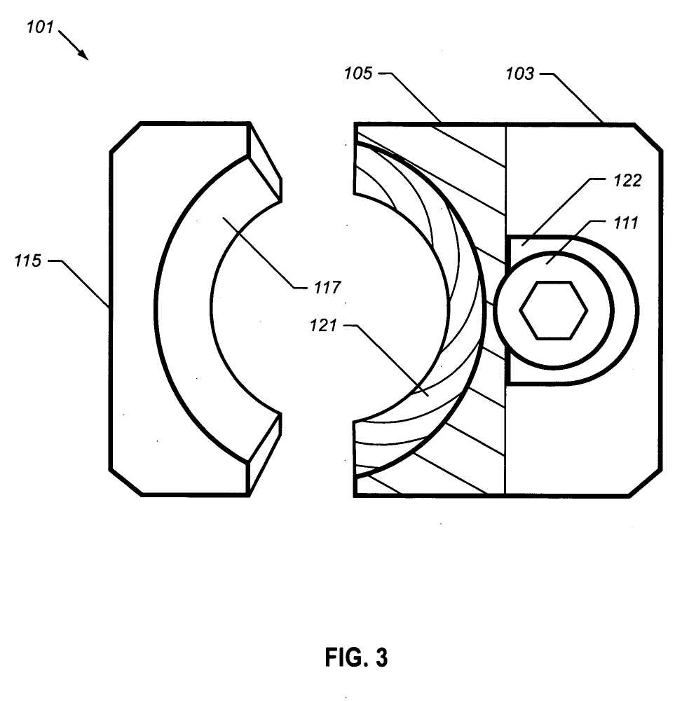

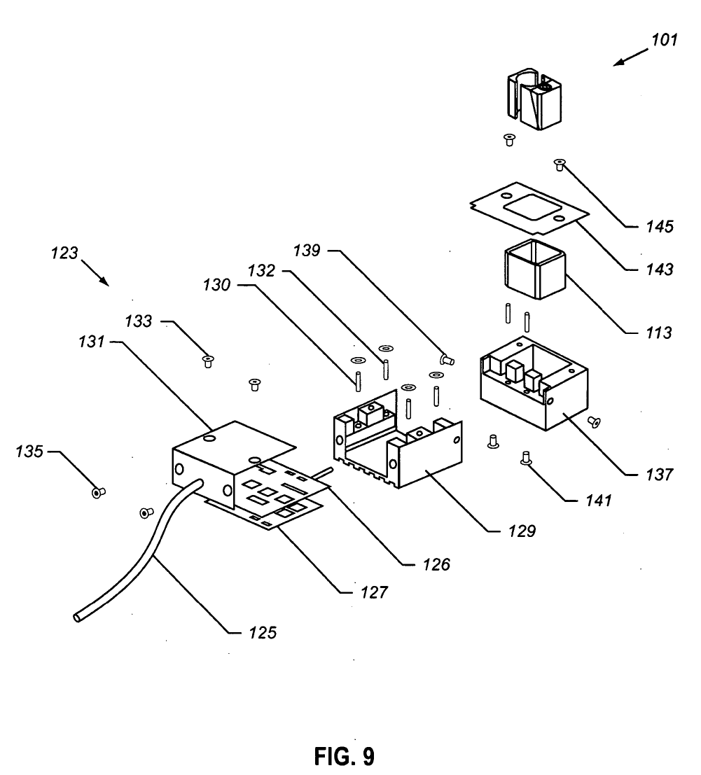

In use, the first 103 and second 105 wedge inserts and the cap screw 111 are disposed within a collar 113 (see FIG. 9) and are placed on one side of the rod-shaped current carrier (not shown). A back insert 115 is positioned within the collar on the opposing surface of the current carrier. The back insert has a curved surface 117 (best seen in FIGS. 2-3) that is complimentary in shape to the exterior surface of the current carrier. Similarly, the first 103 wedge insert has a curved surface 121 (see, e.g., FIG. 3) that is also complimentary in shape to the exterior surface of the current carrier. As the cap screw is tightened, the assembly of the first 103 and second 105 wedge inserts expands. Since this assembly and the back insert are held in place by the rigid collar, the expansion of the assembly causes the clamp assembly to firmly grip the surface of the current carrier.

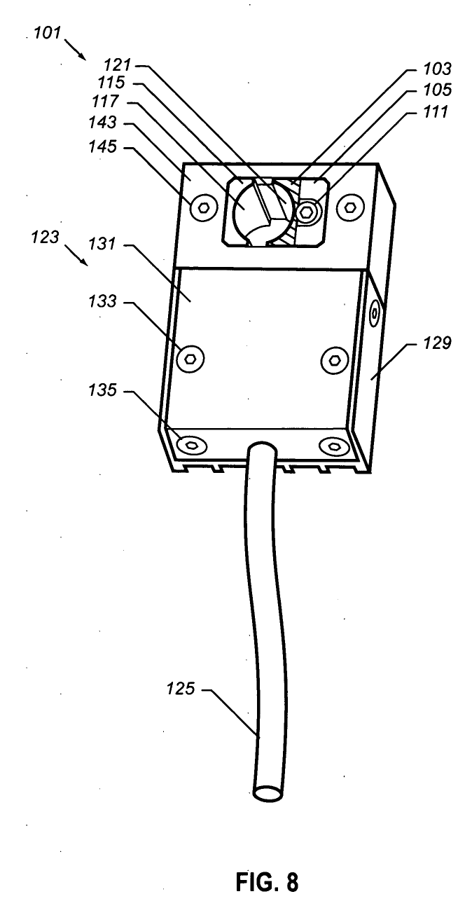

FIGS. 8-9 show different views of one possible embodiment of a complete RF sensor 123 that incorporates the clamp assembly of FIGS. 2-4. The RF sensor includes a cable 125 which connects the internal circuitry of the sensor to a source of electrical current via a power line. In addition to a power line, the cable may contain various other components, such as a ground line, sense lines (e.g., for a DC power supply), communication lines (such as RS-485 cables or the like), and layers or portions (e.g., of aluminum, glass fibers, and the like) that provide electrical, magnetic, or thermal insulation or shielding. The sensor also includes a series of (preferably digital) circuit boards 126, 127 (see FIG. 9) which perform the logical functions of the sensor as are involved, for example, in the measurement of RF voltages, RF currents or DC biases. The circuit boards are secured within a circuit board housing 129 by first 130 and second 132 sets of slotted set screws, it being understood that various other fastening means could also be employed for this purpose.

The circuit boards typically contain the necessary components to perform the desired signal analysis. In the particular embodiment depicted, the RF sensor is shown equipped with two circuit boards. However, in some embodiments, the circuitry of the RF sensor may be condensed into a single circuit board, while in other embodiments, three or more circuit boards may be utilized. The number of circuit boards employed in a given embodiment may be driven by such considerations as ease of manufacture and repair, heat dissipation, shielding, and the functionalities to be provided by the sensor.

A first cover plate 131 is provided to protect the circuit boards from the ambient environment. Various materials can be used for the cover plate, with the ultimate selection typically depending upon such considerations as magnetic shielding, ease of manufacture, durability, and the like. As seen in FIGS. 8-10, the first cover plate 131 is secured to the circuit board housing 129 by way of first 133 and second 135 sets of socket countersunk head cap screws, though other suitable fastening means may also be employed for this purpose. In some embodiments, the first cover plate is also provided with one or more openings designed to accommodate LED indicators that can indicate, for example, whether or not the proper current is being received by the transducer (analog) board 127.

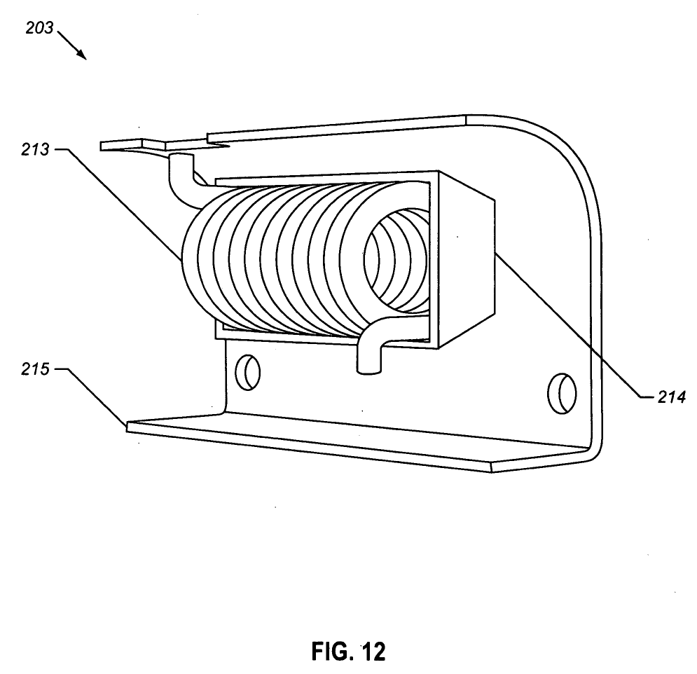

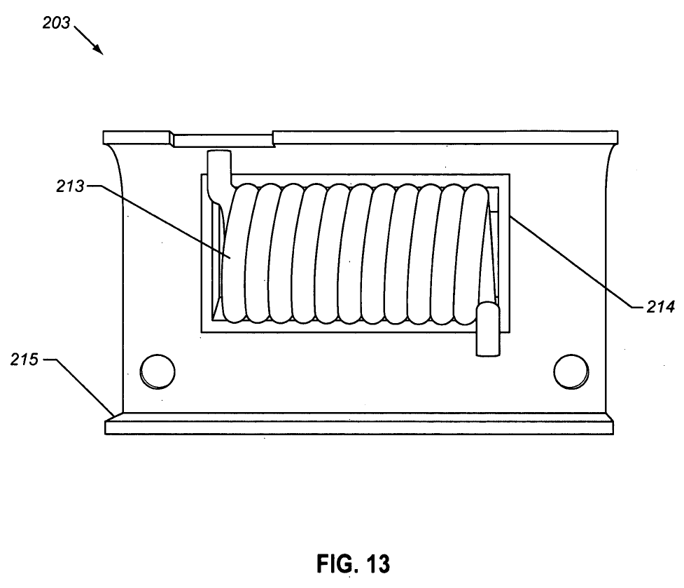

The clamp assembly 101 and collar 113 are disposed within a vespel housing 137 (shown in greater detail in FIGS. 12-13), which is attached to the circuit board housing 129 by way of first 139 and second 141 pairs of socket countersunk head cap screws (see FIG. 9). A second cover plate 143 is provided which is attached to the vespel housing 137 by way of a pair of socket countersunk head cap screws 145. Again, other suitable fastening means may be employed in place of, or in addition to, any of the head cap screws 139, 141 and 145.

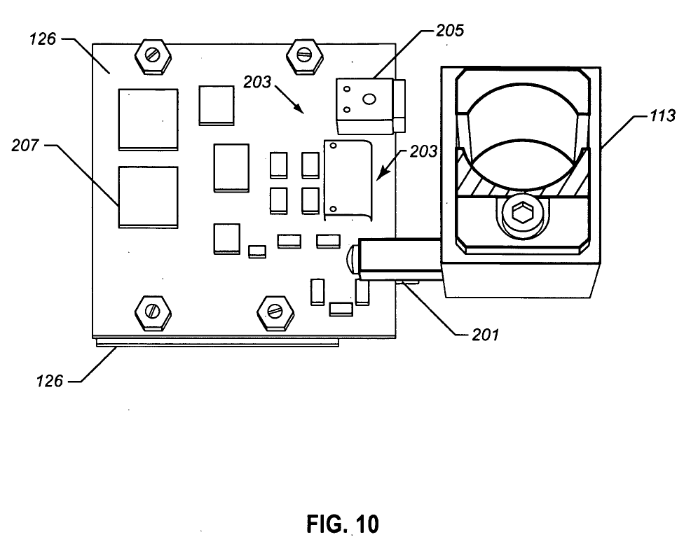

Referring again to circuit boards 126 and 127 (see FIGS. 9-10), in addition to performing the desired signal analyses, in some embodiments, the circuit boards may also comprise one or more memory chips or built-in memory devices which store calibration information that may be used in the signal analysis. Such analysis typically includes Fast Fourier Transfer (FFT) signal analysis, which may be implemented as a firmware algorithm. However, the particular embodiment depicted does not rely upon a firmware algorithm in the DSP chip for the FFT implementation. Rather, it utilizes a pseudo-hardware implementation of the FFT resident on the circuit boards in the form of paradigm circuitry. Consequently, in this embodiment, the memory function is resident in the DSP device itself. Of course, one skilled in the art will appreciate that various embodiments are possible which utilize other FFT implementations or approximations, including hardware, software and firmware implementations, and that various combinations of such implementations or approximations are also possible.

The pseudo-hardware implementation of the FFT as described above, and in particular the implementation of the FFT by hardware rather than software or firmware, is particularly advantageous in high frequency applications, such as applications at 300 MHz or above. At these frequencies, a software implementation of the FFT can become onerous or impractical due to sampling rate requirements. Thus, for example, in order to digitize the wave form in a 300 MHz signal as required to perform the FFT, it would be necessary to sample at a minimum of 600 MHz. Such a sampling rate is challenging to implement with currently available technology. Moreover, even if such a sampling rate is utilized, the resolution (i.e., bit depth) afforded by commonly available Analog to Digital Converters (ADCs) is very poor (about 2-3 bits), and the computational assets required are significant.

One possible solution to this problem is to incorporate heterodyne circuitry into the circuit boards 126, 127. This circuitry uses mixer technology to frequency shift the signal down to lower frequencies. A number of ADCs are presently available that provide sufficient resolution at the output frequencies of the heterodyne circuitry, and hence can be used in conjunction with this circuitry to implement the FFT. However, in the preferred embodiment, the FFT is implemented by a hardware solution that operates in conjunction with the heterodyne circuitry. This hardware solution discretely monitors the amplitudes and phases of each frequency, and thus avoids the need for an ADC prior to implementation of the FFT.

With reference again to FIGS. 9-10, circuit board 126 in this particular embodiment is a transducer board. The transducer board typically comprises a DC bias transducer which is in direct contact with the collar 113, a current transducer, a voltage transducer, and a lead programmable gain amplifier. The transducer board also typically contains the circuitry necessary to input the signals from the transducers at the proper gains.

Circuit board 127 in this embodiment is an analog board that typically contains mixing devices (these include not only mixers, but low pass filters and ADCs as shown in FIG. 21), DSP chips, memory chips or devices, and a Direct Digital Synthesizer (DDS) that sets the local oscillator signal. The DSP chip communicates to the outside world (preferably via a 485 interface, though other suitable interfaces may also be utilized), while also controlling the programmable gain amplifiers and the digitization. The DSP chip also controls the DDS, which in turn controls the local oscillators.

The DSP chip also typically handles calibration of the digital signal output by the hardware. In particular, in the specific embodiment depicted, the DSP chip utilizes the frequency input into the mixer, and the attenuational gain constants retrieved from the memory chip located on the analog circuit board 127, to calibrate the digital signal output by the hardware ADC. This calibrated, digital signal is then transmitted over the (preferably 485) interface. If a 485 interface is utilized, a converter may be provided to convert this signal from 485 to Ethernet.

It will be appreciated from the above discussion that one of the beneficial attributes of some of the devices disclosed herein is the pairing of the transducer package with a memory device that is capable of storing calibration coefficients that correspond to the transducer package. This avoids the need for recalibration in the event that the transducer package must be replaced.

Preferably, the transducer package and memory device are disposed near each other, and even more preferably, the two elements are disposed on the same PCB. However, various embodiments are also possible where this is not the case. For example, embodiments are possible where the memory device is disposed remote from the transducer package. In such embodiments, the memory device will typically be in communication with the signal processing hardware by a hardwire link, through a wireless connection, or by other suitable means. Embodiments are also possible where there is no specific memory device per se, but the calibration coefficients are transmitted, or otherwise made available to the signal processing hardware or software, on an as-needed basis.

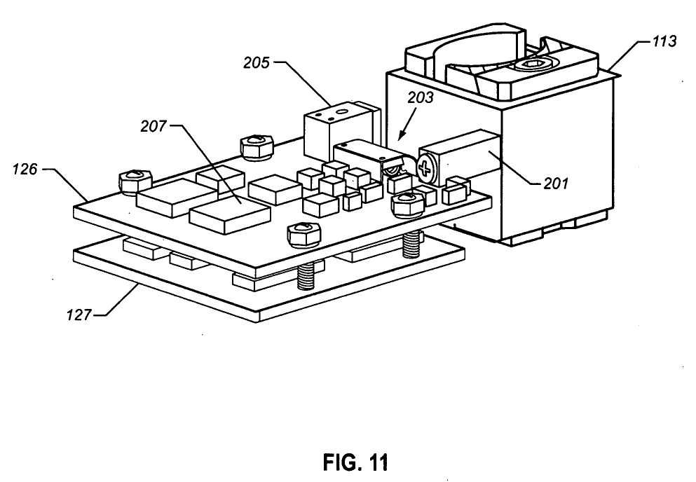

Referring now to FIGS. 10-11, the transducer board 126 is shown in greater detail. The transducer board typically comprises a DC bias transducer 201, a current transducer 203, a voltage transducer 205, and a lead programmable gain amplifier 207. The DC bias transducer 201 is in direct DC contact with the collar 113, and is preferably held in place by a screw terminal which rotatingly engages a threaded aperture (not shown) provided in the surface of the collar 113.

The screw terminal is in electrical communication with a carbon composite resistor. The DC bias transducer, in turn, is in electrical contact with the DC bias circuitry of the board, the later of which contains the DC bias tee network that serves to strip off the RF portion of the signal. The voltage transducer is equipped with a capacitor and is AC coupled to the current carrier to which the clamp is attached. The transducer board is also equipped with the circuitry necessary to input the signals from the transducers at the proper gains.

FIGS. 12 and 13 depict the current transducer 203 in greater detail. The current transducer 203 comprises a transducer coil 213, a coil holder 214 and an electric field shielding mechanism 215. The electric field shielding mechanism 215 is disposed on the transducer board 126 and is positioned over the transducer coil (see FIGS. 11-13). The shielding mechanism or housing preferably comprises a metal such as copper but, as mentioned below, may also comprise various other materials.

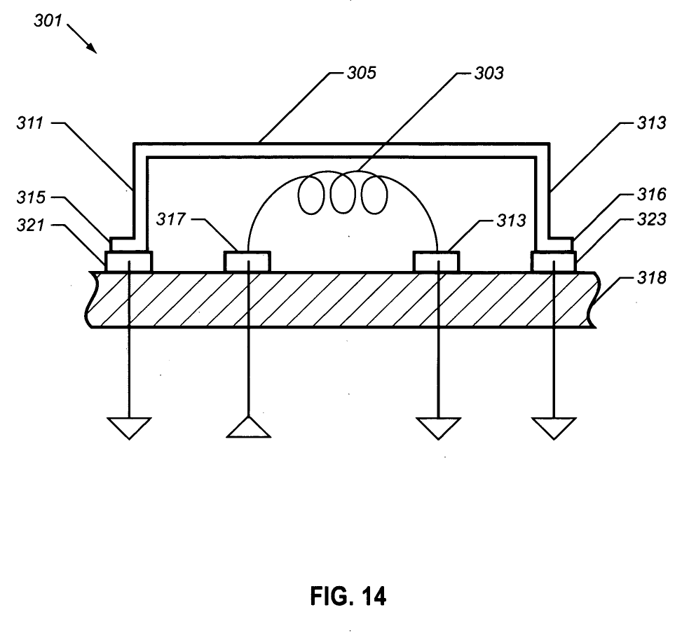

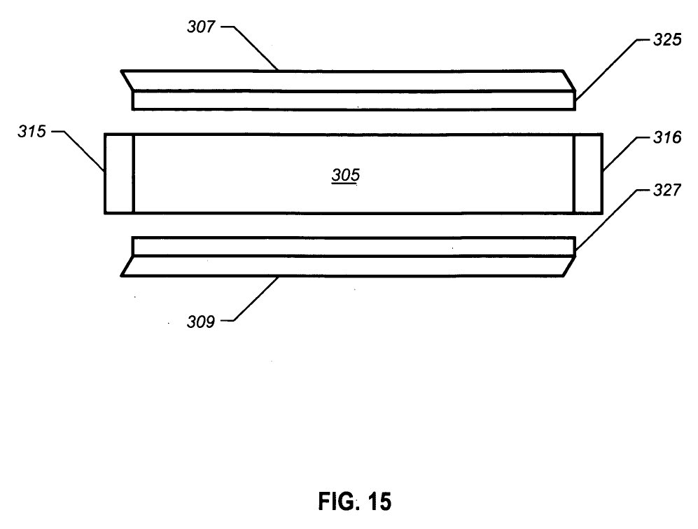

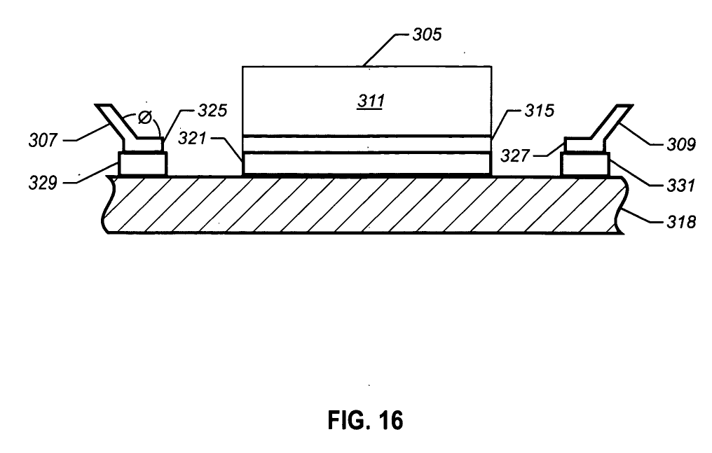

FIGS. 14-16 illustrate a second embodiment of an electric field shielding mechanism 301 for the surface mounted transducer coil 303 of an RF sensor made in accordance with the teachings herein. The shielding mechanism consists of a top 305, first 307 and second 309 side walls (see FIGS. 15 and 16), and first 311 and second 313 end walls (see FIGS. 14 and 16). The end walls terminate in flanges 315, 316 which are mounted to the substrate 318 by way of contact pads 321, 323, respectively. Similarly, the side walls 307, 309 are mounted to the substrate 318 via contact pads 325 and 327, respectively.

The side walls have been omitted from FIG. 14 for the purposes of clarity so that the placement of the surface mounted transducer coil 303 within the housing assembly 301 may be readily appreciated. The transducer coil 303 operates in accordance with Faraday's law, and is mounted to the substrate 318 via first 317 and second 319 contact pads.

The top 305, which is preferably metal, is adapted to prevent crosstalk due to electric field interference from the RF current carrier (not shown) which will be located in magnetic proximity to the transducer coil 303. The side walls 307, 309 are also preferably metal. The primary purpose of the side walls is to isolate the transducer coil 303 from stray electric or magnetic fields which may be present in the ambient environment and which will result in degradation of the measurement due to induced error.

As shown in FIG. 15, which is a top view of the housing assembly 301, the assembly is situated on a substrate 318 such that the first 307 and second 309 side walls are oriented at an angle with respect to the substrate 318, with the side walls slanting away from the top 305. The angle at which the side walls 307, 309 are oriented with respect to the substrate 318 is chosen so that the side walls will not over-attenuate the magnetic field from the primary RF current carrier (not shown). Moreover, as seen in FIG. 16, the side walls 307, 309 are preferably of a different height than the top 305. The result of the angular disposition of the side walls 307, 309 with respect to the substrate 318, and the reduced height of the side walls 307, 309, is to create a sort of funnel for the magnetic field lines of interest from the primary RF current carrier.

As noted above with reference to FIG. 16, side wall 307 is at an angle Ø with respect to via contact pad 325. Similarly, side wall 309 is at an angle Ø with respect to via contact pad 327. Typically, Ø is in the range of 90° to 150°, preferably, Ø is in the range of 90° to 140°, more preferably, Ø is in the range of 90° to 130°, and most preferably, Ø is in the range of 90° to 120°.

While the shielding mechanism depicted in FIGS. 14-16 is useful in some embodiments of the clamping mechanism disclosed herein, the embodiment of the shielding mechanism depicted in FIGS. 10-13 is generally more preferable in the embodiment of the RF sensor shown in FIGS. 8-9. This is due, in part, to the design of the collar 113 and the disposition of the circuit board 126 relative to the collar 113. In particular, when a collar of the type depicted (that is, a collar comprising a large surface area conductor) is utilized, and when the current coil is placed near the middle of such a collar, the resulting design has very well behaved magnetic field lines in the vicinity of the transducer coil. Consequently, side walls 307, 309 of the type depicted in FIGS. 14-16 are not required, such that the more simplistic design for the shielding mechanism depicted in FIGS. 8-9 can be employed. It is to be understood, however, that embodiments which utilize a different collar design, or which have no collar at all, may have much more complicated magnetic field lines, and thus may benefit from the shielding mechanism depicted in FIGS. 14-16.

Various materials may be used in the construction of the shielding mechanisms described herein. Such materials include the following:

MUMETAL™ alloy: an 80% nickel-iron alloy. This high nickel-content alloy conforms to both MIL-N-14411C, Composition 1 and ASTM A753-85, Type 4;

AMUNICKEL™ alloy: a medium permeability material providing greater saturation protection than MUMETAL™ alloy. AMUNICKEL™ alloy is a 48% nickel-iron alloy which conforms to MIL-N-14411C, Composition III, and is useful in applications where saturation is as great a concern as permeability.

CRYOPERM™ 10 alloy: a high nickel content alloy which is specially processed to provide increasing permeabilities with decreasing temperatures.

Ultra Low Carbon Steel (ULCS): An ultra low carbon steel having a relatively high permeability, compared to standard low carbon steels, and excellent saturation characteristics. ULCS can be used together with high permeability materials such as MUMETAL™ alloys to create optimum shields for applications requiring both high saturation protection and high levels of attenuation;

PERMENORM™ 5000 H2: A NiFe alloy with 45-50% Ni and relatively high saturation polarization (1.5-1.6 T) at medium initial and maximum permeabilities;

u-metal: a nickel steel alloy available commercially from Advanced Magnetics, Cambridge, Mass. as product number AD-MU-80.

The elements of the shielding may be of a monolithic construction, or they may have a layered structure. As an example of the later, the shielding may comprise, for example, a base metal which is plated or coated with one or more other metals. Thus, for example, the shielding may comprise lead or tin that is coated with copper. The metals used in the construction of the shielding may also be in the form of one or more alloys. These include, for example, high nickel content, magnetically soft alloys such as the MUMETAL® alloy sold by Goodfellow, Inc. and having the composition Ni₇₇Fe₁₄Cu₅Mo₄.

The shielding may also have layers that are separated from one another by air or by another medium. Thus, for example, the shielding may have inner and outer layers that are separated by a layer of air. As a further example, a layer of low magnetic permeability material may be situated between high magnetic permeability layers in addition to, or in place of, a layer of air. The low magnetic permeability layer is preferably made of a non-ferrous material, such as copper, aluminum, stainless steel or plastic.

In some applications, a single-layer shield cannot provide either the level of attenuation or saturation protection required. In these cases, multi-layer or “nested” shields may be employed. Nesting two or more high permeability shields within one another, and utilizing air gaps provided by spacing between them, results in excellent shielding factors. The more demanding the shielding objectives, the more layers may be required.

When shields need to operate in very high magnetic field environments, as is often the case in plasma etch and deposition applications, the saturation of materials is also a concern. In these cases, nested shields constructed from different compositions of materials are often preferable. The layer closest to the highest field levels is preferably fabricated from a lower permeability, high saturation material. This “buffer” shield and the added attenuation due to the spacing of the air gap can reduce the source field to a level where it is safe to use high permeability materials without the fear of saturation.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the teachings herein and does not pose a limitation on the scope of the invention unless otherwise claimed. No language in the specification should be construed as indicating any non-claimed element as essential to the practice of the invention.

Preferred embodiments of the devices and methodologies disclosed are described herein, including the best mode known to the inventors for carrying out the invention as claimed. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the invention as claimed unless otherwise indicated herein or otherwise clearly contradicted by context.

What is claimed is:

1. An RF sensor, comprising:
a metal collar;
a metal housing disposed on a circuit board adjacent to said collar and having first and second open ends; and
a transducer coil disposed within said housing.

2. The RF sensor of claim 1, wherein said transducer coil is a component of an RF current transducer.

3. The RF sensor of claim 1, further comprising a clamping mechanism disposed within said metal collar which is adapted to releasably attach the RF sensor to a current carrier.

4. The RF sensor of claim 3, wherein said RF sensor is releasably attached to an RF current carrier for a plasma reactor.

5. The RF sensor of claim 1, wherein said circuit board is attached to said metal collar.

6. The RF sensor of claim 1, wherein said housing is open on opposing ends.

7. The RF sensor of claim 1, wherein said housing has first and second walls and a roof, and wherein said first wall is essentially orthogonal to said roof.

8. The RF sensor of claim 8, wherein said second wall is attached to said roof via a curved surface.

9. The RF sensor of claim 1, wherein said housing comprises a nickel-iron alloy.

10. The RF sensor of claim 9, wherein said nickel-iron alloy is an 80% nickel-iron alloy.

11. The RF sensor of claim 1, wherein said housing comprises a first layer comprising a material selected from the group consisting of a nickel-iron alloy, and a second layer comprising iron.

12. The RF sensor of claim 1, wherein said housing comprises copper.

13. An RF sensor, comprising:
a metal collar;
an RF current transducer having a transducer coil disposed on a circuit board, said RF current transducer being disposed adjacent to said collar; and
a metal housing for said transducer coil, said housing being mounted on said circuit board and having first and second open ends.

14. A device, comprising:
an RF current transducer; and
a housing for said transducer, comprising a metal top and metal side walls;
wherein said housing is constructed such that, when it is placed on a planar substrate, said side walls slant away from said top and towards said substrate.

14. The device of claim 13, wherein said side walls are spaced apart from said top.

15. The device of claim 13, wherein said top is higher than said side walls.

16. The device of claim 13, wherein said top is supported by first and second end walls.

17. The device of claim 13, wherein said top wall is grounded.

18. The device of claim 13 in combination with an RF current carrier, wherein said device is located in magnetic proximity to said RF current carrier, and wherein said top is adapted to prevent crosstalk due to electric field interference from said RF current carrier.

19. The device of claim 13, wherein said side walls are adapted to isolate said transducer from ambient electric or magnetic fields.

20. The device of claim 13 in combination with an RF current carrier, wherein said side walls are disposed in such a way that they do not over attenuate the magnetic field associated with said RF carrier.
